(19) United States
(12) Patent Application Publication
(10) Pub. No.: US 2026/0295986 A1
(43) Pub. Date: Oct. 1, 2026

(54) BONDING DEVICE AND BONDING METHOD

(71) Applicants: CHENGDU BOE OPTOELECTRONICS TECHNOLOGY CO., LTD., Sichuan (CN); BIE TECHNOLOGY GROUP CO., LTD., Beijing (CN)

(72) Inventors: Guodong ZHOU, Beijing (CN); Peng WANG, Beijing (CN); Rongkun FAN, Beijing (CN); Jialin WANG, Beijing (CN); Haitao LIANG, Beijing (CN); Fei ZENG, Beijing (CN); Xue MENG, Beijing (CN); Qiang PU, Beijing (CN); Wei ZHOU, Beijing (CN); Lipeng YE, Beijing (CN); Ji HE, Beijing (CN)

(21) Appl. No.: 18/992,616

(22) PCT Filed: Oct. 31, 2022
(86) PCT No.: PCT/CN2022/128509

§ 371 Date: Jan. 9, 2025

(51) Int. Cl. B32B 37/00; B32B 37/10

(52) U.S. Cl. CPC B32B 37/0046; B32B 37/10

(57) ABSTRACT

The present disclosure provides a lamination device and a lamination method, in the lamination device drives the first to-be-laminated film to move towards a direction close to the carrier film, gradually brings the first to-be-laminated film into contact with the second to-be-laminated film from the center to both ends, ultimately causing the first to-be-laminated film to be fully laminated with the second to-be-laminated film to form a to-be-laminated film group. The clamping fixture and the laminating mechanism move synchronously towards a direction close to the flexible laminating pad, such that the flexible laminating pad and the carrier film come into contact in sequence from the center to both ends, squeezing out the bubbles between the carrier film and the flexible laminating pad from both sides.

### CROSS-REFERENCE TO RELATED APPLICATIONS

The present disclosure is a U.S. National Stage of International Application No. PCT/CN2022/128509, filed on Oct. 31, 2022, entitled “BONDING DEVICE AND BONDING METHOD”, the entire content of which is incorporated herein by reference.

### TECHNICAL FIELD

The present disclosure relates to a field of display technology, and more particularly to a lamination device and a lamination method.

### BACKGROUND

Currently, an OLED display screen has been widely used in various electronic products, and with the development of the curved screen, a cover plate with a large-bending curvature has become a new trend, which puts a higher demand on the full lamination manner for a curved cover plate and a flexible display panel.

During the lamination process of a glass cover plate with a convex laminating surface and a flexible panel, issues such as bubbles or wrinkles are prone to occur, which may affect the lamination effect and, consequently, the performance of the display module formed by lamination.

It should be noted that the information disclosed in the Background section above is only for enhancing the understanding of the background of the present disclosure, and thus may include information that does not constitute prior art known to those of ordinary skill in the art.

### SUMMARY

The present disclosure provides a lamination device and a lamination method.

According to an aspect of the present disclosure, the lamination device is provided and includes: a laminating mechanism, including a laminating mold, where the laminating mold has an outwardly-convex laminating surface, the laminating surface is configured to be laminated with a first to-be-laminated film to be fixed, and a shape of the laminating surface is matched with a shape of the first to-be-laminated film; a support mechanism, including a support table and a flexible laminating pad, where the flexible laminating pad is located on a side of the support table facing the laminating mechanism, the flexible laminating pad has a support surface, a shape of the support surface is matched with a shape of the first to-be-laminated film, and a curvature of the support surface is greater than a curvature of the first to-be-laminated film; and a carrier mechanism, including a carrier film and a clamping fixture, where the carrier film is located between the laminating surface and the support surface, a side of the carrier film facing the laminating surface is configured to attach a second to-be-laminated film, and the clamping fixture is clamped at an edge of the carrier film.

In an embodiment of the present disclosure, the laminating surface is defined with a plurality of vacuum adsorption holes, and the plurality of vacuum adsorption holes are uniformly arranged on the laminating surface.

In an embodiment of the present disclosure, the laminating surface is provided with at least one pair of buckles, the pair of buckles includes two buckles, the two buckles are arranged on a periphery of the plurality of vacuum adsorption holes and are arranged close to two opposite straight edges of the laminating surface, respectively, and the buckle is slidable along a curved contour of the laminating surface.

In an embodiment of the present disclosure, the flexible laminating pad includes a main body portion and a lap portion, the lap portion is located on a periphery of the main body portion, and a thickness of the lap portion is less than a thickness of the main body portion; where the lamination device further includes a stopper assembly cooperating with the lap portion to secure a position of the flexible laminating pad.

In an embodiment of the present disclosure, the stopper assembly includes a first stopper fixedly connected to the support table, the first stopper is laminated with a periphery of the lap portion along a first direction, and a bending curvature of the first stopper is the same as a bending curvature of the flexible laminating pad.

In an embodiment of the present disclosure, the stopper assembly further includes a second stopper, the second stopper is connected to a side of the first stopper away from the support table along a third direction, and the second stopper is pressed against the lap portion, and the third direction is a thickness direction of the carrier film.

In an embodiment of the present disclosure, a length of the first stopper is equal to a size of the flexible laminating pad along the first direction, and there are a plurality of second stoppers, and the plurality of second stoppers are uniformly arranged along the first direction.

In an embodiment of the present disclosure, the second stopper is defined with a third mounting hole, a fastener is provided to pass through the third mounting hole to secure a relative position between the second stopper and the first stopper, the third mounting hole is a strip-shaped hole extending along a second direction, and the second direction is perpendicular to the first direction and the third direction.

In an embodiment of the present disclosure, a total thickness of the first stopper and the second stopper is less than a thickness of the main body portion.

In an embodiment of the present disclosure, the stopper assembly further includes a third stopper, and the third stopper is laminated with a periphery of the lap portion along the second direction.

In an embodiment of the present disclosure, a groove is defined on a side of the support table close to the flexible laminating pad, and an orthographic projection of the flexible laminating pad on the support table covers the groove.

In an embodiment of the present disclosure, a difference between a curvature of the laminating surface and a curvature of the second to-be-laminated film is less than 50 -150 mm.

In an embodiment of the present disclosure, the clamping fixture includes two clamping units configured to clamp two opposite sides of the second to-be-laminated film along a first direction, respectively.

In an embodiment of the present disclosure, the clamping unit includes a first clamping structure and a second clamping structure, the first clamping structure includes a first clamping portion, the second clamping structure includes a second clamping portion, the first clamping portion and the second clamping portion are parallel to the carrier film, and the carrier film is clamped between the first clamping portion and the second clamping portion.

In an embodiment of the present disclosure, a part where the first clamping portion and/or the second clamping portion are in contact with the carrier film is provided with a rough surface, the rough surface includes plurality of serrations distributed along the first direction, and the first direction is a length direction of the carrier film.

In an embodiment of the present disclosure, the first clamping structure further includes an arc-shaped connection portion, the arc-shaped connection portion is provided at an end of the first clamping portion along the first direction close to a center of the carrier film, the arc-shaped connection portion is curved in a direction away from the laminating surface, and the first clamping portion is located on a side of the carrier film away from the laminating surface.

In an embodiment of the present disclosure, the second clamping portion is connected to a sliding fitting portion, and an included angle between the sliding fitting portion and the second clamping portion is less than 90 degrees.

In an embodiment of the present disclosure, a sliding groove is provided on a part of the first clamping portion located on an outer side of the carrier film along the first direction, and the sliding fitting portion is slidably fitted within the sliding groove.

According to another aspect of the present disclosure, the lamination method is provided where the lamination device of any of the above embodiments is employed for laminating, and the method includes:
the laminating mechanism driving the first to-be-laminated film to move to a direction close to the carrier film, such that the first to-be-laminated film is fully laminated with the second to-be-laminated film located on the carrier film, to form a to-be-laminated film group; and
the clamping fixture and the laminating mechanism moving synchronously to a direction close to the flexible laminating pad and driving the to-be-laminated film group and the carrier film to move synchronously to the direction close to the flexible laminating pad, until the laminating mechanism and the support mechanism completely press the to-be-laminated film group, the carrier film, and the flexible laminating pad together.

In an embodiment of the present disclosure, the method further includes: when the to-be-laminated film group, the carrier film, and the flexible laminating pad are completely pressed together, maintaining a laminating pressure applied by the laminating mechanism for a predetermined period of time.

It should be understood that the preceding general description and the following detailed description are exemplary and explanatory only and are not restrictive of the present disclosure.

### BRIEF DESCRIPTION OF THE DRAWINGS

The accompanying drawings here are incorporated in the specification and constitute a part of this specification, show embodiments in accordance with the present disclosure and serve to explain the principles of the present disclosure together with the specification.

Obviously, the drawings in the following description are turned only some embodiments of the present disclosure, and for those ordinary skills in the art, other drawings may also be obtained from these drawings without creative efforts.

FIG. 1 is a three-dimensional structural diagram of a lamination device according to embodiments of the present disclosure.

FIG. 2 is a three-dimensional structural diagram of a laminating mechanism according to embodiments of the present disclosure.

FIG. 3 is a three-dimensional structural diagram of a laminating mold according to embodiments of the present disclosure.

FIG. 4 is a three-dimensional structural diagram of a first to-be-laminated film according to embodiments of the present disclosure.

FIGS. 5 to 7 are schematic diagrams of process of positioning a first to-be-laminated film by a laminating mechanism according to embodiments of the present disclosure.

FIG. 8 is a three-dimensional structural diagram of a support mechanism according to embodiments of the present disclosure.

FIG. 9 is a schematic diagram of connection between a support table and a stopper assembly according to embodiments of the present disclosure.

FIG. 10 is a three-dimensional structural diagram of a flexible laminating pad according to embodiments of the present disclosure.

FIG. 11 is a three-dimensional structural diagram of a carrier mechanism according to embodiments of the present disclosure.

FIG. 12 is an enlarged partial view of a carrier mechanism according to embodiments of the present disclosure.

FIG. 13 is a flowchart of a lamination method according to embodiments of the present disclosure.

FIG. 14 is a front view of a lamination device according to embodiments of the present disclosure.

FIG. 15 is a schematic diagram of a state of a lamination device when the laminating mechanism moves downward according to embodiments of the present disclosure.

FIG. 16 is a schematic diagram of a state of a lamination device when a first to-be-laminated film is pre-laminated with a second to-be-laminated film according to embodiments of the present disclosure.

FIG. 17 is a schematic diagram of a state of a lamination device when a first to-be-laminated film is in contact with a center of a flexible laminating pad according to embodiments of the present disclosure.

FIG. 18 is a schematic diagram of a state of a lamination device when a first to-be-laminated film is fully laminated with a flexible laminating pad according to embodiments of the present disclosure.

FIG. 19 is a schematic diagram of a state of a lamination device during pressure maintaining according to embodiments of the present disclosure.

In the drawings: 1—laminating mechanism, 11—laminating mold, 111—laminating surface, 112—vacuum adsorption hole, 12—buckle, 2—support mechanism, 21—support table, 211—groove, 22—flexible laminating pad, 221—main body portion, 2211—support surface, 222—lap portion, 23—stopper assembly, 231—first stopper, 232—second stopper, 233—third stopper, 3—carrier mechanism, 31—carrier film, 32—clamping unit, 321—first clamping structure, 3211—first clamping portion, 3212—arc-shaped connection portion, 3213—sliding groove, 322—second clamping structure, 3221—second clamping portion, 3222—sliding fitting portion 4—first to-be-laminated film, 5—second to-be-laminated film, 6—optical adhesive layer.

### DETAILED DESCRIPTION

Example embodiments will now be described more fully with reference to the accompanying drawings. However, the embodiments may be implemented in a variety of forms and should not be construed as being limited to the examples set forth herein. Rather, these embodiments are provided such that the present disclosure will be more complete so as to convey the idea of the present exemplary embodiments to those skilled in this art. The same reference numerals in the drawings denote the same or similar parts, and the repeated description thereof will be omitted. In addition, the drawings are merely schematic representations of the present disclosure and are not necessarily drawn to scale.

Although relative terms such as “upper” and “lower” are used in this specification to describe the relative relationship of one component shown to another component, these terms are used in this specification only for convenience of description for example according to the direction of the example described. It may be understood that if a device shown is turned upside down, a component described as being “upper” will become a “lower” component. When a certain structure is “on” another structure, it may mean that the certain structure is integrally formed on said another structure, or that the certain structure is “directly” arranged on said another structure, or that the certain structure is “indirectly” arranged on said another structure through an additional structure.

The terms “a”, “an”, “the”, “said” and “at least one” are used to indicate the presence of one or more elements/components/etc.; the terms “include” and “have” are used to indicate an open type meaning of including and means that there may be additional elements/components/etc. in addition to the listed elements/components/etc.; and the terms “first”, “second” and “third” are used as labels only, not a limitation on the number of objects.

At present, after an OLED flexible panel is prepared, a protective cover plate needs to be affixed to an outside of a display screen of the OLED flexible panel to protect the OLED flexible panel. To achieve 3D curved display with the OLED flexible panel, an edge surface of the OLED flexible panel is usually set as an arc-shaped surface, such that an image in its edge region may also be displayed properly during the display. Thus, the edge surface of the protective cover plate is also usually set as an arc-shaped surface, so as to form a curved cover plate that is matched with the flexible panel with the arc-shaped surface. In the present disclosure, “matching” means that the shape is roughly the same.

Currently, in mature applications of mobile phones or vehicle-mounted products, a flexible panel is often laminated onto a concave surface of the curved cover plate, a flexible laminating pad with a convex shape in the center is provided, during the lamination, a clamping fixture stretches a carrier film into an arc shape that matches the flexible laminating pad, and the flexible laminating pad, along with the flexible panel, is moved to a direction close to the curved cover plate, such that the center of the flexible panel and the curved cover plate are in contact, and the lamination progresses gradually from the center to both ends, squeezing out bubbles between the flexible panel and the curved cover plate. It may be understood that the lamination manner requires that the carrier film is used to pre-stretch the flexible panel, and when the carrier film is laminated to the flexible panel, undesirable process effects such as bubbles and wrinkles may occur.

Thus, it is considered to laminate the flexible panel to the convex surface of the curved cover plate. However, due to the special shape of the curved cover plate, the flexible laminating pad cannot be designed in an outwardly-convex form, and as a result, the profiling cannot be performed on the carrier film and flexible panel using the previously mentioned manner. If the carrier film and the flexible panel are not profiled and a pad with a concave center is directly used for lamination, there is a gap between the carrier film and the flexible laminating pad, and the flexible panel cannot be stably placed on the flexible laminating pad, which affects visual alignment, and in addition, premature contact between the curved cover plate and the flexible panel during the lamination process may occur, resulting in the same quality risks, such as bubbles and wrinkles.

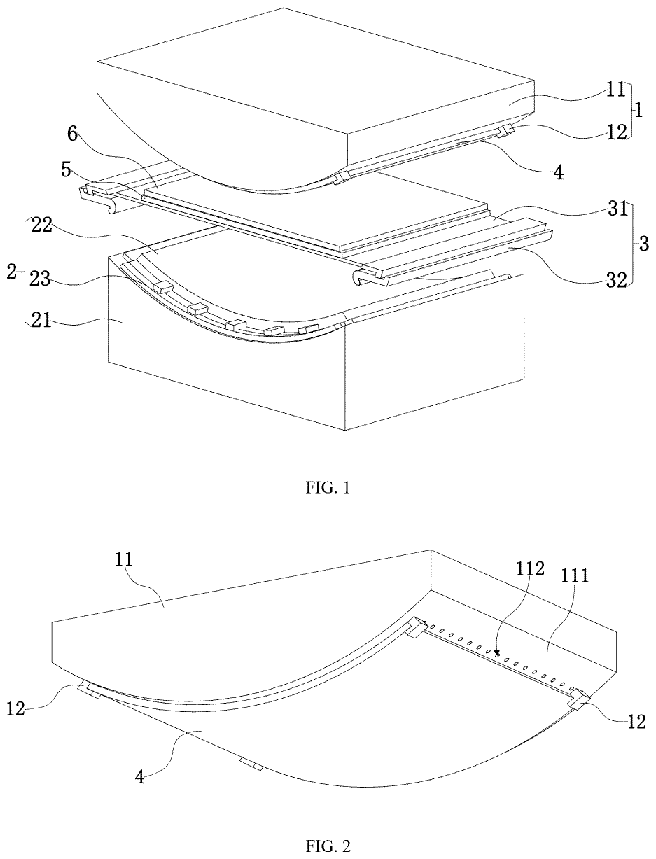

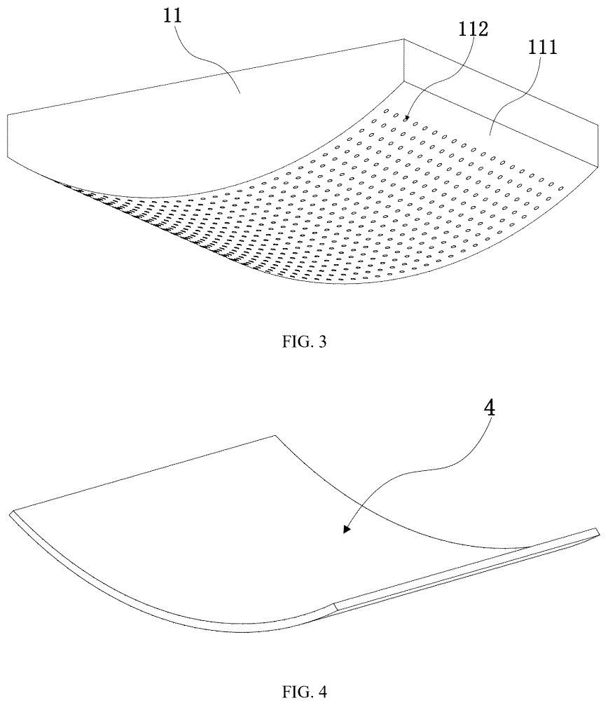

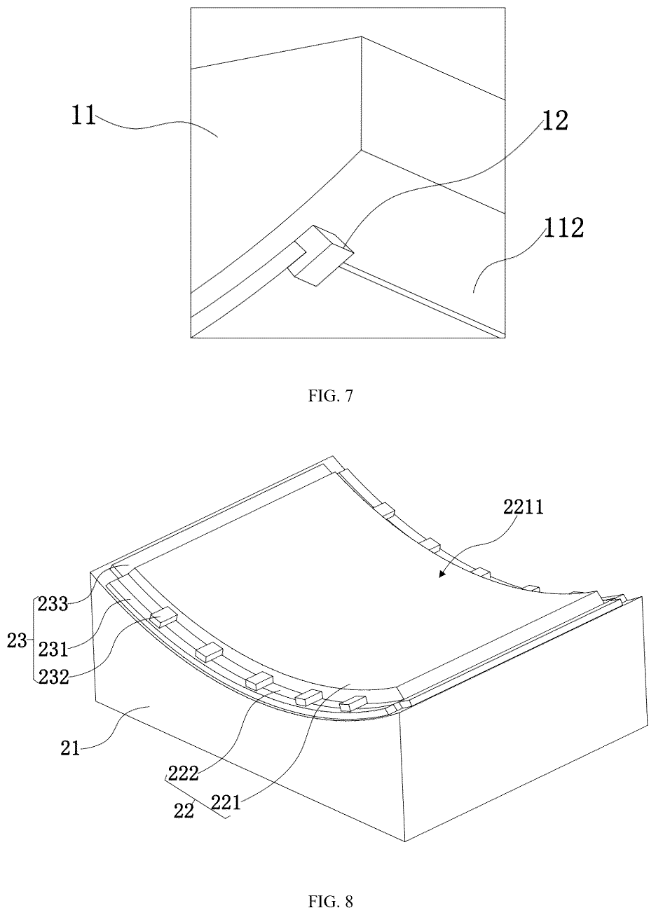

Based on this, the present disclosure provides a lamination device. As shown in FIGS. 1 to 8, the lamination device includes a laminating mechanism 1, a support mechanism 2, and a carrier mechanism 3. The laminating mechanism 1 includes a laminating mold 11 having an outwardly-convex laminating surface 111, the laminating surface 111 is configured to be laminated with a first to-be-laminated film 4 to be fixed, a shape of the laminating surface 111 is matched with a shape of the first to-be-laminated film 4; the support mechanism 2 includes a support table 21 and a flexible laminating pad 22, the flexible laminating pad 22 is located on a side of the support table 21 facing the laminating mechanism 1, the flexible laminating pad 22 has a support surface 2211, a shape of the support surface 2211 is matched with a shape of the first to-be-laminated film 4, and a curvature of the support surface 2211 is greater than that of the first to-be-laminated film 4; the carrier mechanism 3 includes a carrier film 31 and a clamping fixture, the carrier film 31 is located between the laminating surface 111 and the support surface 2211, a side of the carrier film 31 facing the laminating surface 111 is configured to attach a second to-be-laminated film 5, and the clamping fixture is clamped at an edge of the carrier film 31.

The laminating mechanism 1 drives the first to-be-laminated film 4 to move towards a direction close to the carrier film 31, gradually brings the first to-be-laminated film 4 into contact with the second to-be-laminated film 5 from the center to both ends, ultimately causing the first to-be-laminated film 4 to be fully laminated with the second to-be-laminated film 5 located on the carrier film 31, so as to form a to-be-laminated film group. The clamping fixture and the laminating mechanism 1 move synchronously towards a direction close to the flexible laminating pad 22, drive the to-be-laminated film group and the carrier film 31 to move synchronously towards the direction close to the flexible laminating pad 22, due to the curvature of the flexible laminating pad 22 to be greater than that of the first to-be-laminated film 4, the flexible laminating pad 22 and the carrier film 31 come into contact in sequence from the center to both ends, squeezing out the bubbles between the carrier film 31 and the flexible laminating pad 22 from both sides. Thus, there are no bubbles or wrinkles between the first to-be-laminated film 4 and the second to-be-laminated film 5, and the quality of the film group formed by the lamination is relatively stable.

The lamination device is described in detail below in connection with specific embodiments.

As shown in FIGS. 1, 2 to 4, the laminating mechanism 1 has a first connecting surface and a laminating surface 111, the first connecting surface is a flat surface, and the laminating surface 111 is arranged opposite to the first connecting surface. The laminating surface 111 is a curved surface that is outwardly convex towards a side away from the first connecting surface, a shape of the laminating surface 111 is matched with a shape of a concave surface of the first to-be-laminated film 4. The curvature of the laminating surface 111 gradually changes along the first direction, or it may gradually change along the second direction, and the second direction is perpendicular to the first direction. The first direction may be a length direction of the laminating mechanism 1, and the second direction may be a width direction of the laminating mechanism 1. The curvature of the laminating surface 111 is matched with the curvature design of the first to-be-laminated film 4.

The laminating mechanism 1 further has a first side surface and a second side surface, the first side surface and the second side surface connect the first connecting surface to the laminating surface 111 together, and four edges of the first connecting surface are all straight edges, two opposite edges of the laminating surface are straight edges, and the other two opposite edges of the laminating surface are arc-shaped edges. The two first side surfaces connect the two arc-shaped edges of the laminating surface with two straight edges of the first connecting surface, and the two second side surfaces connect the two straight edges of the laminating surface with the other two straight edges of the first connecting surface.

The laminating surface 111 is defined with a plurality of vacuum adsorption holes 112, a negative pressure is created inside the vacuum adsorption holes 112 through air suction, to absorb the first to-be-laminated film 4 that obscures the vacuum adsorption holes 112, such that the first to-be-laminated film 4 is laminated onto the laminating surface 111. The plurality of vacuum adsorption holes 112 are evenly distributed on the laminating surface 111, such that all parts of the first to-be-laminated film 4 are subjected to the adsorption force, to better ensure the lamination effect between the first to-be-laminated film 4 and the laminating surface 111, and prevent the first to-be-laminated film 4 from falling off.

In the present embodiment, the plurality of vacuum adsorption holes 112 are arranged in an array on the laminating surface 111, forming an array of vacuum adsorption holes. The first to-be-laminated film 4 is usually a rigid film, and even if there is a slight difference in the adsorption force of different vacuum adsorption holes 112, the first to-be-laminated film 4 is not be wrinkled. A shape of the array of vacuum adsorption holes is matched with that of the first to-be-laminated film 4. In the present embodiment, the shape of the first to-be-laminated film 4 is rectangular, and accordingly, the array of vacuum adsorption holes is a rectangular array. When the shape of the to-be-laminated film is circular, the array of vacuum adsorption holes may also be a circular array, which is not specifically limited here.

The laminating surface 111 is further provided with two pairs of buckles 12, each pair of buckles 12 including two buckles 12. The two buckles 12 are arranged on a periphery of the array of vacuum adsorption holes, and are respectively arranged close to two opposite straight edges of the laminating surface 111, and the buckles 12 are capable of sliding along a curved contour of the first to-be-laminated film 4 to change its position in the first direction.

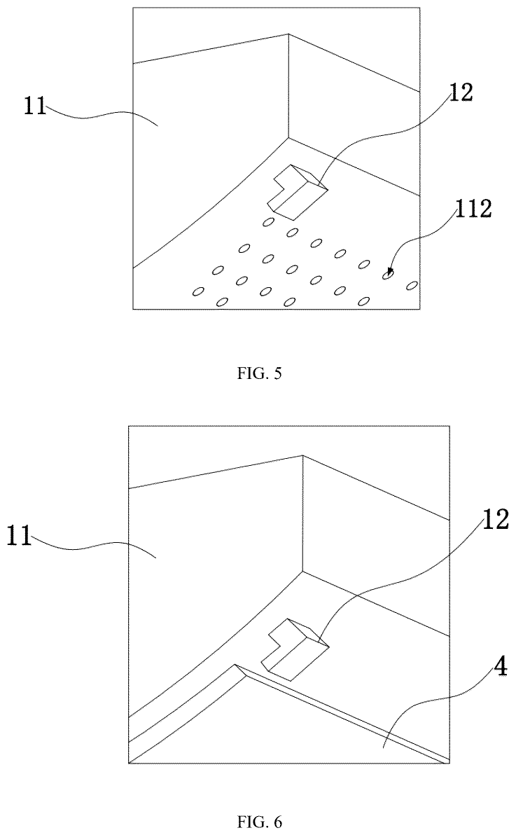

As shown in FIGS. 5 to 7, the first to-be-laminated film 4 is adsorbed through the vacuum adsorption holes 112 on the laminating surface 111. Once the vacuum adsorption is completed, the buckles 12 are driven to slide along the curved contour of the laminating surface 111, such that the buckles 12 abut against the straight edge of the first to-be-laminated film 4. The buckles 12 are continuously driven to slide, which may push the first to-be-laminated film 4 to slide along the laminating surface 111. To ensure the reliability of a sliding trajectory of the buckles 12, a sliding rail that is matched with the curved contour of the laminating surface 111 may be set up to slide the buckle 12 along the sliding rail. The sliding rail may also be set to be retractable, after the first to-be-laminated film 4 is adjusted in place, the sliding rail may be retracted to avoid interference with the movement of the laminating mechanism 1.

A driving mechanism may be provided to drive the position of buckle 12, as an implementation, the driving mechanism may include a pressing cylinder and a limit block, the limit block is respectively connected to the buckle 12 and an action end of the cylinder, and the cylinder exerts force to drive the limit block, which in turn controls the position of the buckle 12 through the limit block. Other driving mechanisms may also be used, such as a gear and a rack system, where the rotation of the gear drives the rack to move, thereby driving the buckle 12 to move. Alternatively, a cam linkage mechanism may be used, where the cam drives a linkage that moves the buckle 12.

The buckle 12 may include a first clip portion and a second clip portion that are connected to each other, the second clip portion may be integrally formed with the first clip portion, and the second clip portion may be perpendicular to the first clip portion. When the buckle 12 abuts against the first to-be-laminated film 4, the second clamping portion is in contact with the straight edge of the first to-be-laminated film 4, and the second clamping portion is in contact with a side of the first to-be-laminated film 4 away from the laminating surface 111.

When the buckle 12 is continuously driven to slide along the curved contour of the laminating surface 111, it may push the first to-be-laminated film 4 to slide along the curved contour of the laminating surface 111, thereby adjusting a fixed position of the first to-be-laminated film 4 in the first direction, ensuring that a part of the first to-be-laminated film 4 where the curvature of the first to-be-laminated film 4 is the minimum curvature first contacts the second to-be-laminated film 5, thereby avoiding the issue of relative angle between the first to-be-laminated film 4 and the laminating surface 111 of the laminating mechanism 1, which may lead to the problem that the accuracy cannot be compensated. It may be understood that when the laminating position of the first to-be-laminated film 4 is adjusted, the first to-be-laminated film 4 will not be damaged under the premise of ensuring its curvature remains unchanged.

Comparatively, the first to-be-laminated film 4 is not affected by the curvature along the second direction, and therefore, it is unnecessary to use the buckle 12 to control the position of the first to-be-laminated film 4 in the second direction. After photographing the first to-be-laminated film 4, the position of the second to-be-laminated film 5 is adaptively adjusted to re-align the second to-be-laminated film 5 with the first to-be-laminated film 4. Of course, a third clip portion (not shown) may also be provided, the third clip portion is perpendicularly connected to the first clip portion and the second clip portion, through the arrangement that the third clip portion abuts against the arc-shaped edge of the first to-be-laminated film 4, the position of the first to-be-laminated film 4 along the second direction may be adjusted.

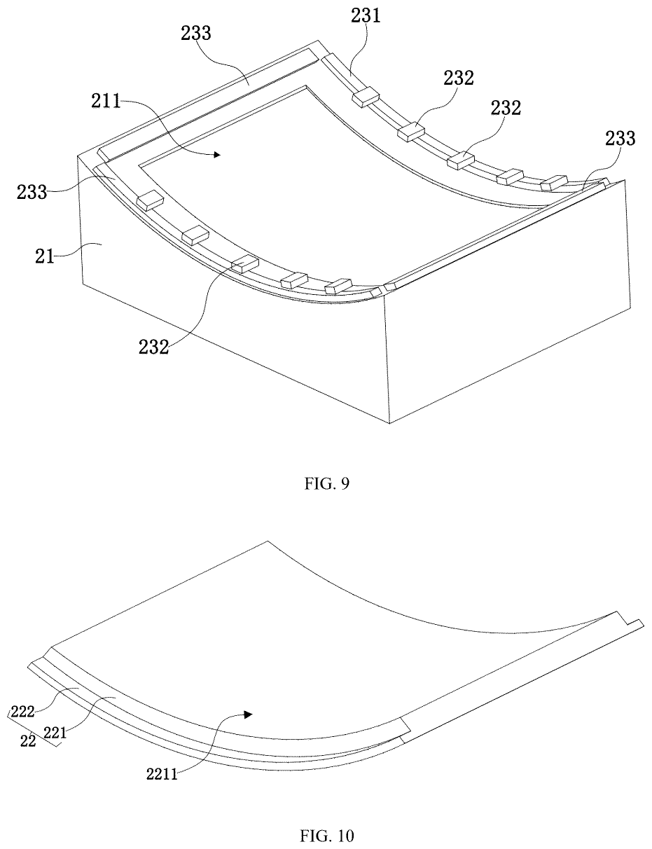

As shown in FIGS. 1, 8 to 10, the support mechanism 2 includes a support table 21 and a flexible laminating pad 22. The flexible laminating pad 22 is located on the side of the support table 21 facing the laminating mechanism 1. The flexible laminating pad 22 has a support surface 2211 and a second connecting surface. The support surface 2211 is a curved surface that is inwardly concave towards a side close to the second connecting surface, and the shape of the support surface 2211 is matched with the convex shape of the first to-be-laminated film 4. It may be understood that the direction of curvature change of the support surface 2211 is matched with the curvature of the laminating surface.

The support mechanism 2 further has a third side surface and a fourth side surface, the third side surface and the fourth side surface connect the second connecting surface with the support surface 2211. The third side surface is located in the same plane as the first side surface, and the fourth side surface is located in the same plane as the second side surface. Four edges of the second connecting surface are all straight edges, two opposite edges of the support surface 2211 are straight edges, and the other two opposite edges of the support surface 2211 are curved edges. The two third side surfaces connect the two curved edges of the support surface 2211 with two straight edges of the second connecting surface, and the two fourth side surfaces connect the two straight edges of the support surface 2211 with the other two straight edges of the second connecting surface.

The flexible laminating pad 22 is made of silicone material, which has excellent electrical insulation performance and a surface resistance of 1012 Ω cm, effectively avoiding electrical breakdown of the film assembly. The deformation of the flexible laminating pad 22 under normal conditions may reach 40%, with excellent compressive deformation performance, and it is not easy to cause plastic deformation, which may affect the lamination quality.

The first to-be-laminated film 4 and the second to-be-laminated film 5 are generally laminated together through an optical adhesive layer 6, an area of the second to-be-laminated film 5 is usually greater than that of the first to-be-laminated film 4, and an area of the optical adhesive layer 6 is usually less than that of the second to-be-laminated film 5. A size of the flexible laminating pad 22 is less than a size of the first to-be-laminated film 4, but greater than a size of the optical adhesive layer 6 (OCA). This is because the primary purpose of the flexible laminating pad 22 is to compress the optical adhesive layer 6 between the first to-be-laminated film 4 and the second to-be-laminated film 5, ensuring that the optical layer is tightly bonded to the first to-be-laminated film 4 and the second to-be-laminated film 5.

A curvature of the flexible laminating pad 22 is slightly less than a maximum curvature of the first to-be-laminated film 4, and a difference between the curvature of the laminating surface and the curvature of the second to-be-laminated film 5 is less than 50 -150 mm, to ensure that the two ends of the first to-be-laminated film 4 may be fully laminated with the two ends of the flexible laminating pad 22, thereby ensuring tightness.

In addition, considering the static deformation of silicone material, the elastic deformation is prone to occur when the flexible laminating pad 22 is not mounted, which increases the curvature release of the flexible laminating pad 22. Thus, in order to avoid the plastic deformation of the flexible laminating pad 22, which may cause deviation in laminating stress, a dedicated transfer fixture needs to be used to fix the curvature of the flexible laminating pad 22.

In order to facilitate the positioning of the flexible laminating pad 22, the flexible laminating pad 22 may be designed with a structure that is thicker in center and thinner at edges along the second direction. The flexible laminating pad 22 includes a main body portion 221 and a lap portion 222, the lap portion 222 is located on a periphery of the main body portion 221, and a thickness of the lap portion 222 is less than that of the main body portion 221. The lamination device also includes a stopper assembly 23, which cooperates with the lap portion 222, and the stopper assembly 23 limits the position of the lap portion 222 in the first, second, and third directions respectively, thereby fixing the position of the flexible laminating pad 22 on the support table 21.

The stopper assembly 23 includes a first stopper 231, which is fixedly connected to the support table 21, the first stopper 231 is laminated to a periphery of the lap portion 222 along the first direction. A size of the first stopper 231 along the first direction is approximately equal to that of the flexible laminating pad 22 along the first direction, and a curvature change of the first stopper 231 is the same as that of the flexible laminating pad. A size of the first stopper 231 along the second direction is less than or equal to a distance between an edge of the flexible laminating pad 22 along the second direction and an edge of the support table 21, and a size of the first stopper 231 along a third direction is equal to a thickness of the lap portion 222 of the flexible laminating pad 22.

The first stopper 231 is defined with plurality of first mounting holes along the first direction, and the support table 21 is defined with second mounting holes that correspond one-to-one with the first mounting holes, a fastener may be provided to pass through the first and second mounting holes to fix the relative position between the first stopper 231 and the support table 21, ensuring that the flexible laminating pad 22 does not shift in position along the second direction.

The stopper assembly 23 further includes a second stopper 232, which is connected to a side of the first stopper 231 away from the support table 21 along the third direction. The second stopper 232 is pressed against the lap portion 222, and overlaps with both the first stopper 231 and the lap portion 222 in the second direction. The degree of freedom of the flexible laminating pad 22 in the third direction is limited through the second stopper 232, which ensures that the position of the flexible laminating pad 22 cannot shift in the third direction.

The second stopper 232 is defined with a third mounting hole, a fastener may sequentially pass through the third mounting hole, the second mounting hole and the first mounting hole, such that the relative position of the second stopper 232, the first stopper 231, and the support table 21 are fixed. The first mounting hole may be set as a strip-shaped hole extending along the second direction, and by adjusting the position of the fastener in the first mounting hole, the position of the second stopper 232 may be freely adjusted in the second direction to ensure the tightness of the flexible laminating pad 22.

It should be noted that a total thickness of the first stopper 231 and the second stopper 232 is less than a thickness of the main body portion 221. When the laminating mechanism 1 and the support mechanism 2 press the film assembly and the flexible laminating pad 22, the total thickness of the first stopper 231 and the second stopper 232 will not be too excessive to block the laminating mechanism 1 from moving downward and affect the laminating process.

In addition, the stopper assembly 23 may further include a third stopper 233, the third stopper 233 is laminated to a periphery of the lap portion 222 along the second direction, which may limit the degree of freedom of the flexible laminating pad 22 in the first direction. The relative position between the third stopper 233 and the support table 21 are fixed to ensure that the flexible laminating pad 22 does not shift in position along the first direction.

The shape of the support table 21 is the same as that of the flexible laminating pad 22, and the curvature of the support table 21 may be equal to that of the flexible laminating pad 22. When the carrier film 31 and the flexible laminating pad 22 are fully laminated together, the pressure at the center of the film group is 0.2 MPa, while the pressure at the four corners is only 0.08 MPa, and under this state, the four corners of the film group are barely compressed, resulting in inadequate lamination and the risk of air bubbles infiltrating. If the laminating mechanism 1 continues to apply pressure to the film group, the center of the film group may be subjected to excessive pressure, the first to-be-laminated film 4 is a rigid film, which may cause the first to-be-laminated film 4 to crack, and there is not much gain in the pressure on the four corners of the film group.

To alleviate the situation where the center of the film group is under an excessive pressure and the four corners are under a relatively less pressure, a groove 211 is defined on a side of the support table 21 close to the flexible laminating pad 22, and an orthographic projection of the flexible laminating pad 22 on the support table 21 covers the groove 211, and thus an area of the groove 211 is less than that of the flexible laminating pad 22. When a depth of the groove 211 is 2 mm and a pressure on the center of the film group is 0.18 Mpa, the pressure on the four corners of the film group reaches 0.8 Mpa. It may be understood that when the lamination of the film group and the carrier membrane 31 is completed, all four corners of the film group are subjected to a relatively high pressure.

In order to further improve the uniformity of pressure on the film group, the depth of groove 211 may be adjusted. The pressures on the center and four corners of the film group are measured, when a ratio of the pressure on the four corners of the film group to the pressure on the center of the film group is the maximum, a depth of groove 211 is an optimal value. The specific manner for adjusting the depth of groove 211 may involve attaching an adhesive tape inside groove 211 to shorten the excavation depth.

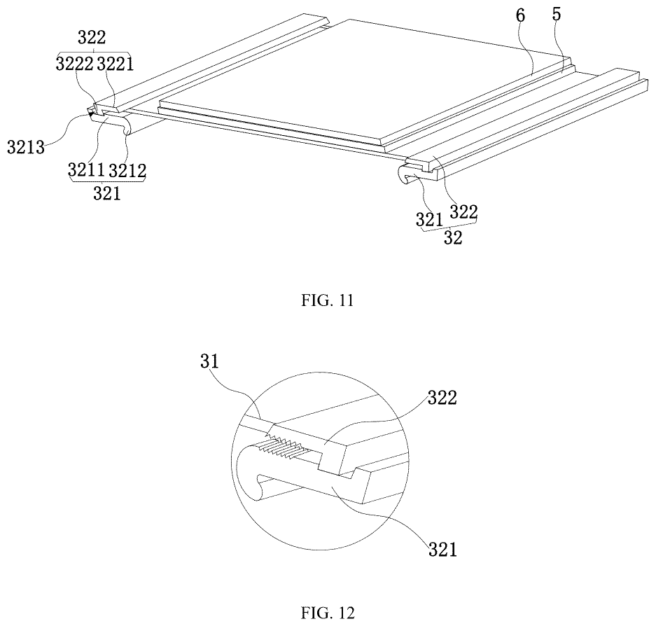

As shown in FIGS. 1 and 11, the carrier mechanism 3 includes a carrier film 31 and a clamping fixture. The carrier film 31 is located between the laminating surface 111 of the laminating mechanism 1 and the support surface 2211 of the support mechanism 2, the clamping fixture is clamped at the edge of the carrier film 31, and a side of the carrier film 31 facing the laminating surface 111 is configured to attach the second to-be-laminated film 5, the second to-be-laminated film 5 is a flexible film. When the laminating mechanism 1 drives the first to-be-laminated film 4 to move in a direction close to the carrier film 31, it drives the first to-be-laminated film 4 and the second to-be-laminated film 5 to gradually contact from the center to both ends.

The clamping fixture may include two clamping units 32, which are respectively configured to clamp the two opposite sides of the second to-be-laminated film 5 along the first direction. The clamping unit 32 may include a first clamping structure 321 and a second clamping structure 322. The first clamping structure 321 includes a first clamping portion 3211, and the second clamping structure 322 includes a second clamping portion 3221. The first clamping portion 3211 and the second clamping portion 3221 are parallel to the carrier film 31, and the carrier film 31 is clamped between the first clamping portion 3211 and the second clamping portion 3221.

As shown in FIG. 12, in order to prevent the relative looseness between the carrier film 31 and the clamping fixture, a part where the first clamping portion is in contact with the carrier film 31 may be set as a rough surface, or a part where the second clamping portion is in contact with the carrier film 31 may be set as a rough surface. In order to further ensure the clamping stability of the clamping fixture, the part where the first clamping portion and the second clamping portion are in contact with the carrier film 31 may also be set as a rough surface. The rough surface may include a plurality of serrations distributed along the first direction, which may be distributed continuously or intermittently, and are not specifically limited here.

The first clamping structure 321 also includes an arc-shaped connection portion 3212, which is provided at an end of the first clamping portion along the first direction close to a center of the carrier film 31. The arc-shaped connection portion 3212 is curved in a direction away from the laminating surface 111, and the first clamping portion may be located on a side of the carrier film 31 away from the laminating surface 111, while the second clamping portion is located on a side of the carrier film 31 close to the laminating surface 111. When the first to-be-laminated film 4 and the second to-be-laminated film 5 are fully laminated, the carrier film 31 is is stretched to have the same curvature as the arc-shaped connection portion 3212, and at this point, the second to-be-laminated film comes into contact with the arc-shaped connection portion 3212, which may alleviate the tensile stress exerted on it.

The first clamping structure 321 further includes a sliding fitting portion 3222, which is connected to the second clamping portion 3221. A clamping amount of the first clamping portion on the carrier film 31 may be controlled by a distance between the sliding fitting portion 3222 and the carrier film 31 in the first direction, which allows for effective clamping of the carrier film 31 while maximizing the available carrier region, providing greater flexibility for adjusting the position of the second to-be-laminated film 5.

An included angle between the sliding fitting portion 3222 and the second clamping portion 3221 is less than 90 degrees, this design enables a single obliquely oriented clamping cylinder to drive the second clamping portion 3221 simultaneously along the first and third directions with a single application of force. This not only ensures higher uniformity in the applied force but also enhances the stability of the clamping process.

Consequently, the clamping time for the carrier film 31 is reduced, thereby improving the overall lamination efficiency of the film group. It should be noted that the third direction is perpendicular to both the first and second directions, and that is, the third direction is the thickness direction of the laminating mechanism 1.

A sliding groove 3213 is provided on a part of the first clamping portion located on an outer side of the carrier film along the first direction, and the sliding fitting portion 3222 is slidably fitted within the sliding groove 3213. The sliding groove 3213 is inclined, and its inclination angle is the same as the inclination angle of the sliding fitting portion 3222. That is, when the clamping fixture clamps the carrier film 31, the sliding fitting portion 3222 and two side walls of the sliding groove 3213 are parallel to each other. By setting the size of the sliding groove 3213 along the first direction, a movement stroke of the sliding fitting portion 3222 may be limited, thereby controlling the clamping degree of the second clamping portion 3221 on the carrier film 31. This ensures the clamping of the carrier film 31 without causing damage.

The film group mentioned earlier may be a large-sized vehicle-mounted display module. At this point, the first to-be-laminated film 4 is a curved cover plate, and the second to-be-laminated film 5 is a flexible panel, which may be an OLED display panel. It may be understood that the vehicle-mounted display module formed by using this lamination device is free from the interference of bubbles or wrinkles, and the display quality is better.

The following provides a detailed description of the above-mentioned vehicle-mounted display module and the corresponding lamination device.

As shown in FIGS. 1 to 12, when the first to-be-laminated film 4 is a curved cover plate, a length of the first to-be-laminated film 4 is 389 mm, a width of the first to-be-laminated film 4 is 219 mm, a thickness of the first to-be-laminated film 4 is 1 mm, a depth of the first to-be-laminated film 4 is 43.5 mm, and a curvature of the first to-be-laminated film 4 varies gradually between 250-750 mm. The minimum curvature, 250 mm, occurs at the deepest part of the first to-be-laminated film 4, while the maximum curvature, 750 mm, occurs at both ends of the first to-be-laminated film 4. When the second to-be-laminated film 5 is the flexible panel, a length of the second to-be-laminated film 5 is 332 mm, and a width of the second to-be-laminated film 5 is 213 mm. The optical adhesive layer 6 is located between the first to-be-laminated film 4 and the second to-be-laminated film 5, and the first to-be-laminated film 4 and the second to-be-laminated film 5 are bonded together through the optical adhesive layer 6. A length of the optical adhesive layer 6 is 331.6 mm, and a width of the optical adhesive layer 6 is 210 mm.

The curvature of the laminating surface 111 of the laminating mechanism 1 matches the corresponding range of 250-750 mm. The plurality of vacuum adsorption holes 112 are arranged in a 17 ×25 rectangular array on the laminating surface 111, and a diameter of the vacuum adsorption holes may be 0.8-1.2 mm. Specifically, there are 25 vacuum adsorption holes 112 arranged along the first direction, with a spacing of 8-12 mm between adjacent vacuum adsorption holes 112, and there are 17 vacuum adsorption holes 112 arranged along the second direction, with a spacing of 10-15 mm between adjacent vacuum adsorption holes 112, which allows the normal adsorption of the entire surface at 0.16-0.24 Mpa, effectively avoiding the first to-be-laminated film 4 from falling off.

The length of the flexible laminating pad 22 is 337 mm, the width of the flexible laminating pad 22 is 230 mm, and the depth of the flexible laminating pad 22 is 38.8 mm. The flexible laminating pad 22 along the second direction includes a main body portion 221 and a lap portion 222, and the lengths of the main body portion 221 and the lap portion 222 along the first direction are all 337 mm, the width of the main body portion 221 is 317 mm, the width of the lap portion 222 is 10 mm, the thickness of the main body portion 221 is 8.5 mm, and the thickness of the lap portion 222 is 3.5 mm.

As mentioned earlier, in the case where the flexible laminating pad 22 is not mounted with the support table 21, the flexible laminating pad 22 undergoes the elastic deformation. Corresponding to the maximum curvature of the first to-be-laminated film 4, the maximum curvature of the flexible laminating pad 22 may be 600-700 mm, and this maximum curvature of the flexible laminating pad 22 may be released from 600-700 mm to 750-850 mm. To avoid the plastic deformation of the flexible laminating pad 22, which may cause deviation in laminating stress, a corresponding transfer fixture needs to be used to match the flexible laminating pad 22.

The length of the support surface 2211 of the laminating mechanism 1 may be set to 357 mm, the width of the support surface 2211 of the laminating mechanism 1 may be set to 250 mm, a 2 mm groove 211 is defined on the support surface 2211, and an orthographic projection of the flexible laminating pad 22 on the support surface 2211 covers the groove 211. A part of the support surface 2211 where the flexible laminating pad 22 is mounted may be provided with a stopper assembly 23, the stopper assembly 23 includes a first stopper 231, a second stopper 232, and a third stopper 233, the first stopper 231 is arranged on an outer side of the lap portion 222 along the first direction, and the second stopper 232 is arranged on a side of the first stopper 231 away from the support table 21, and the second stopper 232 overlaps with both the first stopper 231 and the lap portion 222 in the second direction. The third stopper 233 is fitted with a periphery of the lap portion 222 along the second direction.

The length of the first stopper 231 is 337 mm, the width of the first stopper 231 is 10 mm, the thickness of the first stopper 231 is 3.5 mm, and the maximum curvature is 600-700 mm. The thickness of the first stopper 231 is the same as that of the lap portion 222 of the flexible laminating pad 22, and the material of the first stopper 231 is metallic. The length of the second stopper 232 is 18 mm, the width of the second stopper 232 is 5 mm, the thickness of the second stopper 232 is 2 mm, and the material of the second stopper 232 is also metallic. It may be understood that the sum of the thicknesses of the first stopper 231 and the thickness of the second stopper 232 is 5.5 mm, which is obviously less than the thickness of the main body portion 221 of the flexible laminating pad 22. The length of the third stopper 233 is 230 mm, the width of the third stopper 233 may be 10 mm, and the thickness of the third stopper 233 may be 3.5 mm.

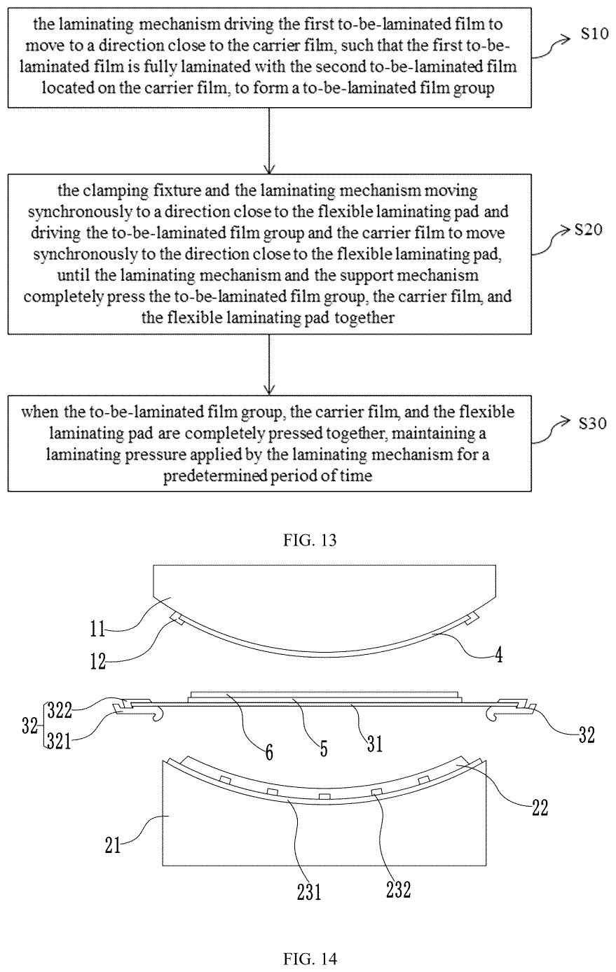

Embodiments of the present disclosure also provide a lamination method, which uses any of the lamination devices described above for laminating. As shown in FIG. 13, the method may include:

in step S10, the laminating mechanism drives the first to-be-laminated film to move to a direction close to the carrier film, such that the first to-be-laminated film is fully laminated with the second to-be-laminated film located on the carrier film, to form a to-be-laminated film group;

in step S20, the clamping fixture and the laminating mechanism move synchronously to a direction close to the flexible laminating pad and drive the to-be-laminated film group and the carrier film to move synchronously to the direction close to the flexible laminating pad, until the laminating mechanism and the support mechanism 2 completely press the to-be-laminated film group, the carrier film, and the flexible laminating pad together.

As the lamination method is achieved through the lamination device provided in embodiments of the present disclosure, the beneficial effects of the lamination method may refer to the beneficial effects of the lamination device, and will not be repeated here.

Before performing the lamination process, the relative positions of the first to-be-laminated film, the second to-be-laminated film, and the flexible laminating pad need to be determined.

As shown in FIG. 14, the concave surface of the first to-be-laminated film 4 is first attached to the laminating surface of the laminating mechanism, and the vacuum suction is applied through the vacuum adsorption holes, such that the first to-be-laminated film 4 is attached to the laminating surface. The lamination accuracy of the first to-be-laminated film 4 is then checked, if there is any misalignment, the buckles 12 are driven to slide along the curved contour of the laminating surface, which may push the first to-be-laminated film 4 to slide along the laminating surface, adjust the relative position of the first to-be-laminated film 4 and the laminating surface in the first direction, until the curvature of the first to-be-laminated film 4 and the laminating surface are perfected matched.

After photographing the first to-be-laminated film 4, its position along the second direction is checked. If there is a deviation in the relative position between the second to-be-laminated film 5 and the first to-be-laminated film 4 in the second direction, the position of the second to-be-laminated film 5 should be adaptively adjusted along the second direction to re-align it with the first to-be-laminated film 4.

The flexible laminating pad 22 is placed on the support table 21, ensuring that the orthographic projection of the flexible laminating pad 22 on the support table 21 covers the groove. The first stopper 231, the second stopper 232, and the third stopper are mounted, ensuring that the first stopper 231, the second stopper 232, and the third stopper are in close contact with the flexible laminating pad 22, and that the first stopper 231, the second stopper 232, and the third stopper are stable and not loose, to ensure the positional accuracies of the flexible laminating pad 22 in the first, second, and third directions.

Generally, a first housing is provided on a side of the laminating mechanism away from the support mechanism, and a second housing is provided on a side of the support mechanism away from the laminating mechanism. The second housing cooperates with the first housing to form an enclosed laminating space. In order to reduce the generation of laminating bubbles, the first bonding to-be-laminated film 4 and the second bonding to-be-laminated film 5 need to be laminated in a vacuum environment, so it is necessary to ensure that the laminating space is in a vacuum state.

The next step is to laminate the first to-be-laminated film and the second to-be-laminated film.

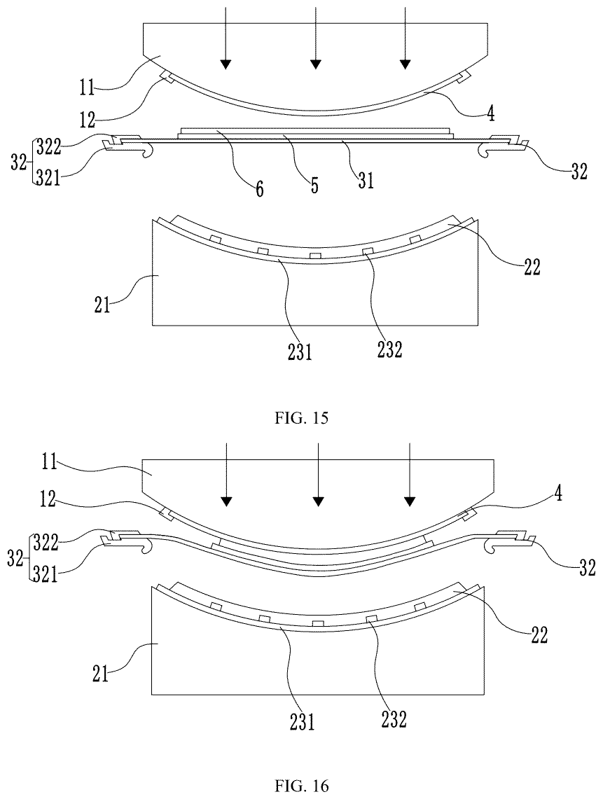

As shown in FIGS. 15 and 16, in step S10, the center of the first to-be-laminated film (the part with the minimum curvature) comes into contact with the center of the second to-be-laminated film first, and when the laminating mechanism drives the first to-be-laminated film to continue moving towards the direction of the carrier film, it drives the first to-be-laminated film and the second to-be-laminated film to gradually come into contact from the center to both ends. When the first to-be-laminated film is fully laminated with the second to-be-laminated film, the carrier film is stretched to have the same curvature as the arc-shaped connection portion, and at this time, the second to-be-laminated film comes into contact with the arc-shaped connection portion of the first clamping structure.

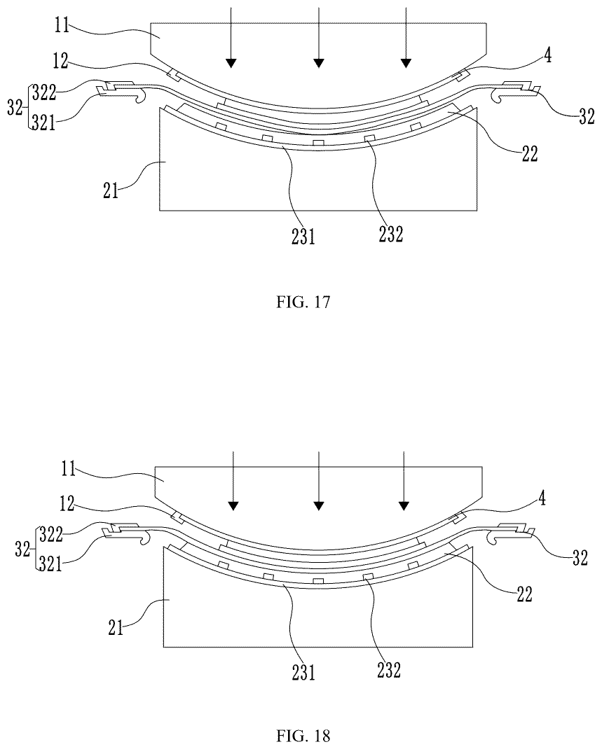

As shown in FIGS. 17 and 18, in step S20, the clamping fixture and the laminating mechanism move synchronously towards a direction close to the flexible laminating pad 22, drive the to-be-laminated film group and the carrier film 31 to move synchronously towards the direction close to the flexible laminating pad 22. Since the curvature of the flexible laminating pad 22 is greater than that of the first to-be-laminated film 4, the carrier film 31 first contacts with the center of the flexible laminating pad 22, ensuring stress compression in the central region of the film group. As the clamping fixture and the laminating mechanism continue to move, the flexible laminating pad 22 and the carrier film 31 come into contact in sequence from the center to both ends, squeezing out the bubbles between the carrier film 31 and the flexible laminating pad 22 from both sides until the to-be-laminated film group, the carrier film 31, and the flexible laminating pad 22 are fully pressed together.

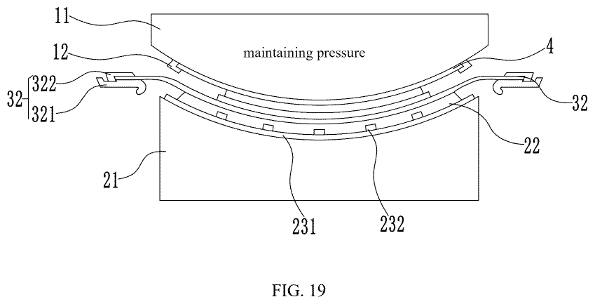

As shown in FIG. 19, the method may further include step S30, where when the to-be-laminated film group, the carrier film, and the flexible laminating pad are fully pressed together, a laminating pressure applied by the laminating mechanism is maintained for a predetermined period of time.

The preset maintaining time may further ensure the adhesion effect of the first to-be-laminated film 4 and the second to-be-laminated film 5. In the present embodiment, the preset duration may usually be set to 5 seconds.

Other embodiments of the present disclosure will be apparent to those skilled in the art after those skilled in the art consider the specification and practice the technical solutions disclosed herein. The present disclosure is intended to cover any variations, uses, or adaptations of the present disclosure, which are in accordance with the general principles of the present disclosure and include common general knowledge or conventional technical means in the art that are not disclosed in the present disclosure. The specification and embodiments are illustrative, and the real scope and spirit of the present disclosure is defined by the appended claims.

1. A lamination device, comprising:
a laminating mechanism, comprising a laminating mold, wherein the laminating mold has an outwardly-convex laminating surface, the laminating surface is configured to be laminated with a first to-be-laminated film to be fixed, and a shape of the laminating surface is matched with a shape of the first to-be-laminated film;
a support mechanism, comprising a support table and a flexible laminating pad, wherein the flexible laminating pad is located on a side of the support table facing the laminating mechanism, the flexible laminating pad has a support surface, a shape of the support surface is matched with a shape of the first to-be-laminated film, and a curvature of the support surface is greater than a curvature of the first to-be-laminated film; and
a carrier mechanism, comprising a carrier film and a clamping fixture, wherein the carrier film is located between the laminating surface and the support surface, a side of the carrier film facing the laminating surface is configured to attach a second to-be-laminated film, and the clamping fixture is clamped at an edge of the carrier film.

2. The lamination device according to claim 1, wherein the laminating surface is defined with a plurality of vacuum adsorption holes, and the plurality of vacuum adsorption holes are uniformly arranged on the laminating surface.

3. The lamination device according to claim 2, wherein the laminating surface is provided with at least one pair of buckles, the pair of buckles comprises two buckles, the two buckles are arranged on a periphery of the plurality of vacuum adsorption holes and are arranged close to two opposite straight edges of the laminating surface, respectively, and the buckle is slidable along a curved contour of the laminating surface.

4. The lamination device according to claim 1, wherein the flexible laminating pad comprises a main body portion and a lap portion, the lap portion is located on a periphery of the main body portion, and a thickness of the lap portion is less than a thickness of the main body portion; wherein the lamination device further comprises a stopper assembly cooperating with the lap portion to secure a position of the flexible laminating pad.

5. The lamination device according to claim 4, wherein the stopper assembly comprises a first stopper fixedly connected to the support table, the first stopper is laminated with a periphery of the lap portion along a first direction, and a bending curvature of the first stopper is the same as a bending curvature of the flexible laminating pad.

6. The lamination device according to claim 5, wherein the stopper assembly further comprises a second stopper, the second stopper is connected to a side of the first stopper away from the support table along a third direction, and the second stopper is pressed against the lap portion, and the third direction is a thickness direction of the carrier film.

7. The lamination device according to claim 6, wherein a length of the first stopper is equal to a size of the flexible laminating pad along the first direction, and there are a plurality of second stoppers, and the plurality of second stoppers are uniformly arranged along the first direction.

8. The lamination device according to claim 6, wherein the second stopper is defined with a third mounting hole, a fastener is provided to pass through the third mounting hole to secure a relative position between the second stopper and the first stopper, the third mounting hole is a strip-shaped hole extending along a second direction, and the second direction is perpendicular to the first direction and the third direction.

9. The lamination device according to claim 6, wherein a total thickness of the first stopper and the second stopper is less than a thickness of the main body portion.

10. The lamination device according to claim 8, wherein the stopper assembly further comprises a third stopper, and the third stopper is laminated with a periphery of the lap portion along the second direction.

11. The lamination device according to claim 1, wherein a groove is defined on a side of the support table close to the flexible laminating pad, and an orthographic projection of the flexible laminating pad on the support table covers the groove.

12. The lamination device according to claim 1, wherein a difference between a curvature of the laminating surface and a curvature of the second to-be-laminated film is less than 50 -150 mm.

13. The lamination device according to claim 1, wherein the clamping fixture comprises two clamping units configured to clamp two opposite sides of the second to-be-laminated film along a first direction, respectively.

14. The lamination device according to claim 13, wherein the clamping unit comprises a first clamping structure and a second clamping structure, the first clamping structure comprises a first clamping portion, the second clamping structure comprises a second clamping portion, the first clamping portion and the second clamping portion are parallel to the carrier film, and the carrier film is clamped between the first clamping portion and the second clamping portion.

15. The lamination device according to claim 14, wherein a part where at least one of the first clamping portion and/or the second clamping portion are-is in contact with the carrier film is provided with a rough surface, the rough surface comprises plurality of serrations distributed along the first direction, and the first direction is a length direction of the carrier film.

16. The lamination device according to claim 14, wherein the first clamping structure further comprises an arc-shaped connection portion, the arc-shaped connection portion is provided at an end of the first clamping portion along the first direction close to a center of the carrier film, the arc-shaped connection portion is curved in a direction away from the laminating surface, and the first clamping portion is located on a side of the carrier film away from the laminating surface.

17. The lamination device according to claim 15, wherein the second clamping portion is connected to a sliding fitting portion, and an included angle between the sliding fitting portion and the second clamping portion is less than 90 degrees.

18. The lamination device according to claim 17, wherein a sliding groove is provided on a part of the first clamping portion located on an outer side of the carrier film along the first direction, and the sliding fitting portion is slidably fitted within the sliding groove.

19. A lamination method, wherein the lamination device according to claim 1 is employed for laminating, and the method comprises:
the laminating mechanism driving the first to-be-laminated film to move to a direction close to the carrier film, such that the first to-be-laminated film is fully laminated with the second to-be-laminated film located on the carrier film, to form a to-be-laminated film group; and
the clamping fixture and the laminating mechanism moving synchronously to a direction close to the flexible laminating pad and driving the to-be-laminated film group and the carrier film to move synchronously to the direction close to the flexible laminating pad, until the laminating mechanism and the support mechanism completely press the to-be-laminated film group, the carrier film, and the flexible laminating pad together.

20. The lamination method according to claim 19, further comprising:
in response to that the to-be-laminated film group, the carrier film, and the flexible laminating pad are completely pressed together, maintaining a laminating pressure applied by the laminating mechanism for a predetermined period of time.
